(19) United States
(12) Patent Application Publication
(10) Pub. No.: US 2016/0321315 A1
(43) Pub. Date: Nov. 3, 2016

(54) APPLICATION FRAMEWORK

(71) Applicant: QUALCOMM Technologies International, Ltd., Cambridge (GB)

(72) Inventors: Mauro SCAGNOL, Cambridge (GB); Nicolas GRAUBE, Cambridge (GB)

(21) Appl. No.: 14/698,302

(22) Filed: Apr. 28, 2015

(51) Int. Cl. G06F 17/30

(52) U.S. Cl. CPC G06F 17/30371; G06F 17/30864

(57) ABSTRACT

An integrated circuit chip comprises a processor, memory, a database and an application framework. The application framework is configured to support first and second applications, each application being associated with a respective database comprising respective data. The framework is configured to dynamically arrange a modified database in dependence on the respective databases. The modified database comprises the respective data such that they are independent.

### BACKGROUND OF THE INVENTION

This invention relates to an application framework. In particular the invention relates to an application framework for application development, download and/or update.

Recently there has been an increase in the use of low-cost devices such as those capable of being used in a network, which might comprise many such devices. Devices can support wired and/or wireless communication protocols to facilitate use of the devices in one or more networks. In one example, devices can support at least one of the Bluetooth and Bluetooth Low Energy (BLE, also known as Bluetooth Smart) protocols. An example of this is the concept of the Internet of Things, where different networks, such as within a home, may link together to provide coherence to the functioning and/or control of the network(s).

An example of a function, or service, that such a device can provide is lighting management. In one mode of deployment, the devices can communicate with a wired or wireless network so as to be responsive to a switch command—for example to switch lights on or off. An example of such a device is a BLE-enabled light bulb which can connect with a BLE switch and other BLE-enabled light bulbs to form a network. One example of such a network is a CSRmesh network.

In the context of a ‘smart building’ a building manager may wish to deploy hundreds of such interconnected light bulbs, to achieve centralised, remote management and building performance optimisation. However, the penetration of wireless controlled devices in, for example a smart building context, has been limited by the perception that this technology is not yet mature. Since the planned lifetime of commercial buildings before refitting is typically twenty years, building designers need to adopt long term plans. The economic viability and operational reliability of solutions involving the removal of wired/cabled controllers in favour of wireless command and control replacements therefore needs to be evaluated carefully.

In some contexts, network-connectable devices such as window or door sensors may be remote from a source of mains power. Battery-operated devices can, in some situations, operate for many years on a single battery charge, and may be designed to operate for the full lifetime of a consumer product of which they are a part.

These devices are typically single chip devices. A single embedded application controls the operation of the entire chip. The application can describe a single service or functionality. The development of such embedded applications is typically monolithically achieved. To update the functionality of the device the monolithic package can be updated. In other words, the functionality of the whole chip needs to be updated at the same time.

As the above examples show, some such devices are intended to have a relatively long operational/useful lifetime. The progression of functions over time, the ability to swap functions or introduce new functions on old hardware therefore needs to be considered.

With such single service monolithic packages, it is not possible to provide additional functionality alongside that of the originally-provided functionality, such as an additional service, without providing a completely new monolithic package (discussed in more detail below). Where providing such a new monolithic package is not possible, this can mean that devices are limited to their original functionality, even where additional functionality and/or services could be made available. In these situations, to obtain additional functionality, an additional device or node would then also need to be deployed, leading to an undesirable increase in the number of devices deployed, and additional cost in deploying and maintaining the additional devices.

In some instances, multiple services can be described in a monolithic package. This necessitates manually achieving co-existence of the services on the chip during development. This approach restricts the provision of services from more than one supplier in the same monolithic package, since the co-existence needs to be addressed at the development stage. The multiple services are defined in a single code corpus. This means that all services must be considered at the same time. When updating one of the services, the other service(s) on that chip must still be considered since the whole package needs to be updated at once. This leads to complexity and potential delays in the development of these multiple service devices.

### SUMMARY OF THE INVENTION

According to a first aspect of the present invention, there is provided an integrated circuit chip comprising a processor, memory and a database, the chip further comprising an application framework configured to:
support a first application and a second application, the first application being associated with a first database and the second application being associated with a second database, the first database comprising first data associated with the first application and the second database comprising second data associated with the second application;

dynamically arrange a modified database in dependence on the first database and the second database, the modified database comprising the first data and the second data such that the first data and the second data are independent in the modified database.

The memory may be for storing program instructions for execution on the processor. The database may be for reference by the processor during execution of the program instructions.

The framework may be configured to dynamically arrange the modified database such that the first data and the second data are segregated in the modified database.

The arrangement of the first and second data independently in the modified database allows the single modified database to enable independent running of the first application and the second application. This arrangement may allow the separate consideration of the first application and the second application during application development, maintenance and update.

The independent arrangement of the first data and the second data in the modified database may enable enhanced data security, for example between the first application and the second application. The application framework may be arranged so that the first application only has access, such as read/write access, to that portion of the modified database where the first data is stored, and/or that the second application only has access, such as read/write access, to that portion of the modified database where the second data is stored. In this way, the first application may be unable to access data associated with the second application, and the second application may be unable to access data associated with the first application.

The first application and the second application may define independent services. The framework may be configured to enable secure run-time deployment of the first application and the second application. In other words, the framework may be configured to be secure, in that data integrity and confidentiality is maintained between the first application and the second application.

The independent arrangement of the first data and the second data in the modified database may reduce or avoid conflict in accessing database entries in the modified database. For example, the independent arrangement of these data may mean that the first and second applications will not attempt to access the same entry in the modified database at the same time, and/or at different times. This may mean that the behaviour of one of the first application and the second application is independent of the behaviour of the other of the first application and the second application. In other words, one of the applications does not use the same entry in the modified database as the other of the applications.

The application framework may be configured to instantiate the first application and/or the second application. In other words, the application framework may be arranged to run the first application and the second application, or to cause the first application and the second application to run.

The application framework may be configured to dynamically create the modified database in dependence on the first database and the second database. In other words, the modified database might not previously exist. The application framework may be configured to dynamically modify the modified database. This might mean that the modified database is pre-existing. The modified database may be pre-existing where at least one of the first and second applications has already been instantiated, for example by the application framework. The modified database may be pre-existing where it has been created as part of a development process during the development of at least one of the first and second applications.

The integrated circuit chip may comprise the modified database. The application framework may comprise the modified database.

The framework may be configured to, in dynamically arranging the modified database in dependence on the first database and the second database, combine the first database and the second database so as to arrange the modified database. Where the modified database is not pre-existing, the framework may be configured to create the modified database.

The application framework may be configured to dynamically arrange the modified database in dependence on a third database comprising third data associated with a third application, the modified database comprising the first data, the second data and the third data such that the first data, the second data and the third data are independent in the modified database. The framework may be configured to dynamically arrange the modified database such that the first data, the second data and the third data are segregated in the modified database.

The framework may be configured to dynamically modify the modified database in dependence on the third database. In other words, the modified database comprising the first data and the second data may be modified so as to additionally comprise the third data.

The framework may be configured to enable the operation of at least one of the first application, the second application and the third application. This may allow the integrated circuit chip to access the functionality of the at least one of the first application, the second application and the third application. This may be achieved by enabling independent access, such as read/write access, to the modified database by the at least one of the first application, the second application and the third application.

The framework may be configured to dynamically arrange the modified database at run-time. In this way the framework may support the running of at least one of the first application, the second application and the third application.

The framework may be configured to dynamically arrange the modified database in advance of running at least one of the first application, the second application and the third application. This arrangement may reduce the time taken at run-time.

At least one of the first database, the second database and the third database may be a GATT database. At least one of the first database, the second database and the third database may be application-specific. The second database may be different to the first database. The third database may be different to at least one of the first database and the second database. In other words, the first database may relate to the first application, and/or the second database may relate to the second application, and/or the third database may relate to the third application.

The chip may comprise a crypto-block. The framework may be configured to enable at least one of the first application, the second application and the third application to register at least one key set with a crypto-block on the chip. This may enhance at least one of the data integrity and confidentiality of the first application and/or the second application and/or the third application. The key set may comprise at least one key. The at least one key set may be an application instance-specific key set. The at least one key set may be a segregated application key set.

The framework may be configured to cause at least one of the first application and the second application to execute in restricted non-privileged mode. This may mean that the relevant application is unable to access at least one of another application's data and/or code, and data and/or code of the framework. It may additionally or alternatively mean that the relevant application is unable to modify their GATT interface to the external world. This arrangement may reduce data leakage, which may enhance security.

The framework may be implemented in at least one of software, hardware and firmware, or any combination of software, hardware and firmware. The framework may be Cloud-based. In other words, the framework may be accessible remotely, for example over a network such as the Internet.

The framework may be configured to enable two or more of the first application, the second application and the third application to share resources. The framework may be configured to enable two or more of the first application, the second application and the third application to share resources through one or more common application programming interfaces (APIs). The APIs may be at least one of GATT, GAP, CSRmesh, PIO and NVM. The framework may be configured to enable access to the one or more common APIs through at least one trusted gateway function. In other words, access to the APIs may be exposed through the at least one gateway function. The gateway function may be arranged to arbitrate between the applications requesting access to a resource. In other words, the framework may allow multiple concurrent access to one or more restricted resource. There may be a single point of arbitration of the resource.

The framework may be configured so that said at least one trusted gateway function reserves and/or limits at least one of the sharing and ownership of designated functionality, for example of a peripheral. The framework may be configured so that said at least one trusted gateway function reserves and/or limits at least one of the sharing and ownership of a peripheral. The framework may be configured so that said at least one trusted gateway function restricts a switch to privileged non-restricted supervising mode to trusted gateway function code. The framework may be configured so that said at least one trusted gateway function causes resources to be time-shared between applications such as the first, second and/or third applications. The framework may be configured so that said at least one trusted gateway function causes real-time constraints to be matched by a Real-Time Operating System (RTOS). The chip may comprise the RTOS. In this way, the framework may facilitate efficient operation of functionality controlled by the chip.

The RTOS may facilitate the operation of the framework in unrestricted privileged mode. This may enable application-specific databases, such as GATT databases, to be dynamically and securely arranged into the modified database.

The framework may be configured to enable the first application, the second application and/or the third application to be at least one of defined, signed, deployed and updated in isolation of one another. The framework may be configured to enable the first application, the second application and/or the third application to be developed in isolation. In other words, the framework may be configured to enable at least one of the first, second and third applications to be deployed independently of another of at least one of the first, second and third applications. This may facilitate the independent maintenance and/or update of the applications. This may facilitate the independent maintenance and/or update of the services provided by the applications.

The framework may be configured to enable at least one of deployment, maintenance and update of at least one of the first application and the second application by one or both a wired and a wireless protocol. The wireless protocol may be at least one of Bluetooth and Bluetooth Low Energy (BLE, also known as Bluetooth Smart). The wireless protocol may be compatible with a CSRmesh network. The framework may be configured to enable at least one of deployment, maintenance and update of at least one of the first application, the second application and the third application by Over The Air updates (OTAu). The framework may be configured to enable OTAu to the chip.

The framework may be configured to download encrypted and/or signed applications (such as a first application), for example applications signed by the developer and distribution framework. Such applications may be encrypted with the public key of the destination chip, and distributed to the chip in encrypted form. In some examples, such applications may be encrypted with a symmetric key. The key exchange may be facilitated through a Diffie-Hellman exchange. The public key of the chip may be used to authenticate the chip. This can enhance security of the applications. The framework may be configured to decrypt and verify the application signatures.

The framework may be a para-virtualisation framework. The para-virtualisation framework may be a lightweight real-time operating system (RTOS)-based para-virtualisation framework.

Any one or more feature of any aspect above may be combined with any one or more feature of any other aspect above. Any apparatus feature may be rewritten as a method feature, with the necessary changes being made in the wording. These have not been written out in full here merely for the sake of brevity.

### BRIEF DESCRIPTION OF THE DRAWINGS

The present invention will now be described by way of example with reference to the accompanying drawings. In the drawings:

FIG. 1 shows a schematic representation of a framework;

FIG. 2 shows another schematic representation of a framework;

FIG. 3 shows another schematic representation of a framework; and

FIG. 4 shows schematic interactions of applications in a framework.

### DETAILED DESCRIPTION OF THE INVENTION

The following description is presented to enable any person skilled in the art to make and use the invention, and is provided in the context of a particular application. Various modifications to the disclosed embodiments will be readily apparent to those skilled in the art.

The general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

As an example of a single-service monolithic package, it is possible for Bluetooth Low Energy (BLE)-enabled light bulbs to be controlled using a lighting service (for example, in a CSRmesh network the light bulbs could be controlled using the CSRmesh Lighting Model—here Model in the context of a CSRmesh network is analogous to a service in a BLE context; a model is a group of messages and associated actions defining a behaviour implemented within the mesh).

Each light bulb is a remotely controllable end-node. The light bulb can switch on and off in response to commands issued in the lighting service. It is also possible for the light bulb to act as a relay for mesh packets which are addressed to other BLE-enabled light bulbs (such as CSRmesh-enabled light bulbs) or light switches, or indeed other devices in the same network supporting different services (or, in an example, CSRmesh models).

It would be undesirable to install multiple devices to achieve different functionalities in the same network, where those functionalities could be achieved using the original device (i.e. the light bulb). For example, it would be difficult to justify why additional nodes should be deployed to support CSRmesh-based asset tracking when CSRmesh-compliant light bulbs are already deployed in the building, just because the original firmware of the light bulbs cannot be upgraded, or the original vendor does not support an asset tracking model and hence is not offering an upgrade including both light bulb and asset tracking models.

Whilst there are mechanisms for providing a device with more than one service, these mechanisms are unattractive in practice, as will be briefly described below.

One mechanism for providing additional services that could be implemented in a CSRmesh system using the μEnergy toolkit is through access to the CSRmesh source code. Knowledge of this code could allow a developer to develop an additional service or functionality that is compatible with the originally developed service. However, this mechanism is not possible where the source code is not known. Since, typically, the source code will not be externally known, this mechanism is only of very limited use and may not be generally applicable.

Further, in typical implementations, where more than one service is defined, there may be data leakage between services. This can be highly undesirable, and could in some instances compromise the security of a system. This may especially be the case where services are provided by different vendors. Another aspect of operation that would need to be considered is that of time sharing between services of common resources.

Thus whilst there are many devices with limited capabilities, it has been recognised by the present inventors that at least some of these devices could be providing additional services, beyond the originally envisaged service. The present techniques aim to address this by introducing the ability to develop independent services, independent models, and/or operating system support for co-existence and the ability to offer updates so as to enable deployment and update of applications without requiring an entire package to be considered at once. This may enable modifications of the service or functionality at a finer grain of delivery, i.e. updating only part of a larger package where desired. In other words, it may enable OTAu at a finer grain of delivery. This approach may allow differential updates or service-based updates or installations.

Here, the concept of ‘co-existence’ comprises distinct applications (or processes) concurrently operating. It might also be termed co-habitation to describe the concurrent operation of the applications (or processes), as enabled by the framework.

The constraints, such as of the monolithic package, can be traced back to the development environment and/or proposed operating system supporting the applications.

In the context of a network of BLE- or CSRmesh-enabled devices, the present techniques present a system and method to express concurrent services, each of them defined, developed, signed and dynamically deployed in isolation. The present techniques enable a network owner to let an already-deployed network expand using securely segregated applications from one or multiple vendors.

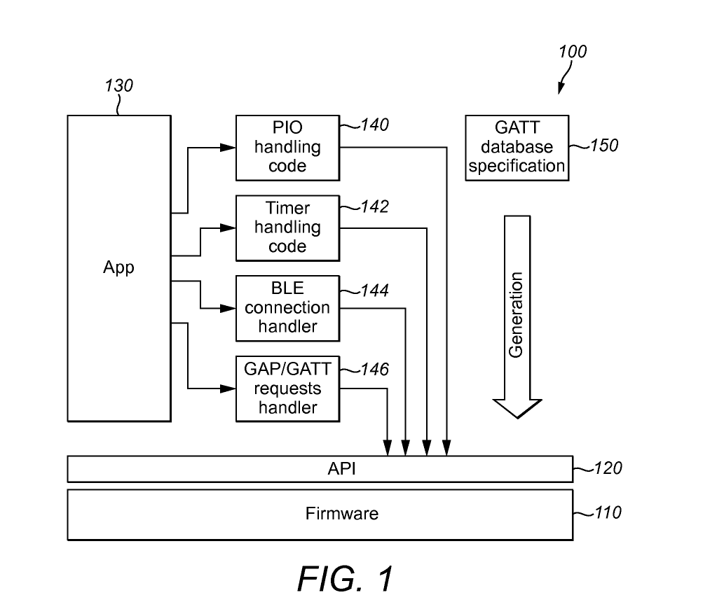

In an example of a single-service device (shown schematically in FIG. 1), a basic framework 100 comprises firmware 110 operating on a chip. An application programming interface (API) 120 is provided for interacting with the firmware 110. An application 130 may interface with the API 120 through various request handlers such as a PIO code handler 140, a Timer code handler 142, a BLE connection handler 144 and a GAP/GATT requests handler 146. A GATT database specification 150 is defined which is specific to the application 130.

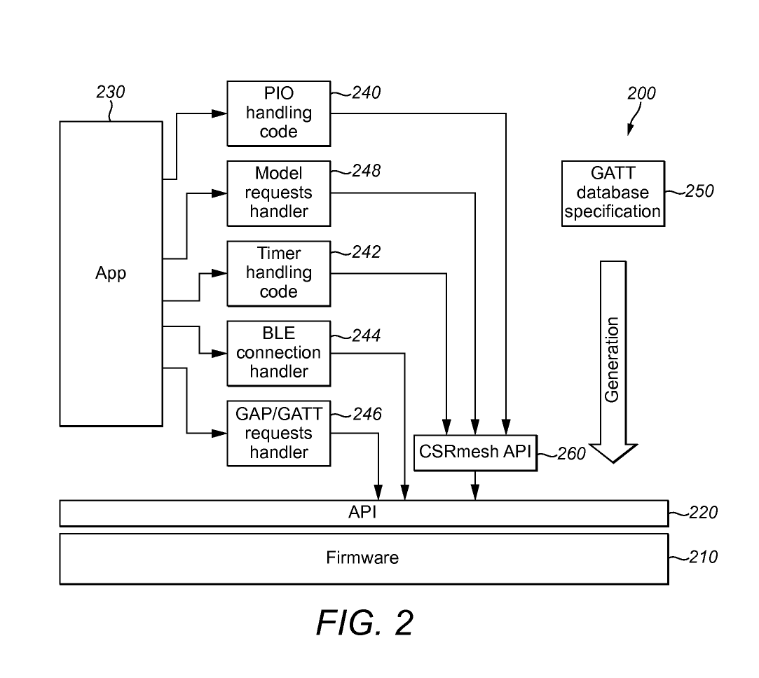

In another example of a single-service device, which is capable of networking in a CSRmesh network (shown schematically in FIG. 2), a single application framework 200 comprises firmware 210 operating on a chip. An API 220 is provided for interacting with the firmware 210. An application 230 may interface with the API 220 through various request handlers such as a BLE connection handler 244 and a GAP/GATT requests handler 246. In this example there is also provided a CSRmesh API 260 which interfaces with the API 220. The application 230 additionally interfaces with the API 220 through the CSRmesh API 260. The application 230 interfaces with the CSRmesh API 260 through various request handlers such as a PIO code handler 240, a Timer code handler 242 and a Model requests handler 248. A GATT database specification 250 is defined which is specific to the application 230.

The application may comprise boiler-plate code which is centred around more or less one large switch statement where all is shared. Thus application data is accessible within the whole of the framework. This does not pose a problem where the framework is limited to supporting a single application, but as mentioned herein, data security issues become relevant when considering the move to a new system which can support multiple applications which are separately deployable.

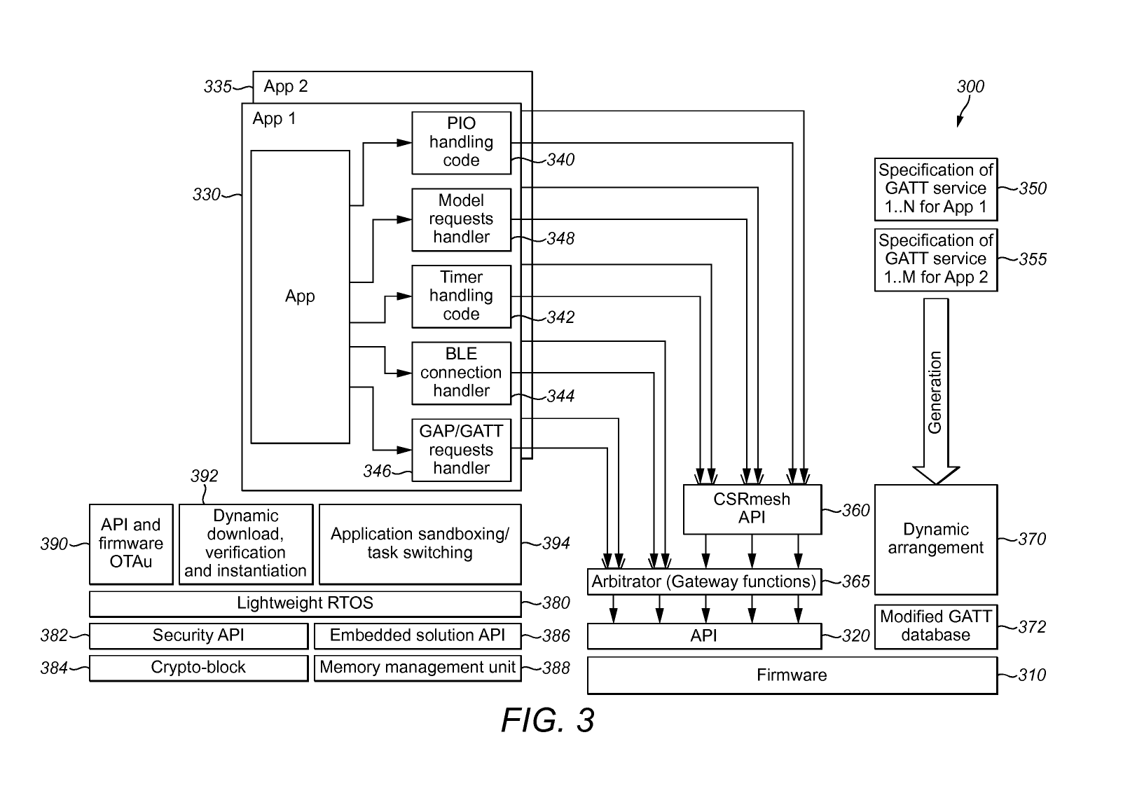

A new application framework 300 will now be described with reference to FIG. 3. As above, the framework 300 comprises firmware 310 operating on a chip (not shown). An API 320 is provided for interacting with the firmware 310. An arbitrator 365 comprising gateway functions sits above the API 320 (in other words, interfacing of an application with the API 320 goes through the arbitrator 365. This allows the arbitrator to control at least some aspects of operation of the application). Similarly, a CSRmesh API 360 sits above the arbitrator 365. (Here, ‘above’ means that the referenced block may be provided at a higher level than the block which it is above and indicates the way in which interactions may be processed by the framework.)

A first application 330 interfaces with the API 320 through the arbitrator 365 using a first set of request handlers, which comprises a BLE connection handler 344 and a GAP/GATT requests handler 346. The first application 330 interfaces with the API 320 through both the CSRmesh API 360 and the arbitrator 365 using a second set of request handlers, which comprises a PIO handler 340, a Timer handler 342 and a Model requests handler 348.

Similarly, a second application 335 also interfaces with the API 320 through the arbitrator 365 using the first set of request handlers, and interfaces with the API 320 through both the CSRmesh API 360 and the arbitrator 365 using a second set of request handlers.

In this way, the arbitrator 365 is effectively aware of the operations of both the first application 330 and the second application 335. The arbitrator 365 can therefore control the operations of the first and second applications to as to facilitate their operational co-existence in the framework 300.

The first application 330 has an associated specification of a GATT service. The specification is in the form of a first database 350, and comprises first data (such as first data elements 1 . . . N) relating to a first service specific to the first application 330. The second application 335 also has an associated specification of a GATT service. The specification is in the form of a second database 355, and comprises second data (such as second data elements 1 . . . M) relating to a second service specific to the second application 335.

The term database as used herein does not refer to any particular data structure or arrangement. The database is a form of data storage. Suitably, the database may comprise code and/or data. This can allow the possibility to execute the applications from a data space. In other words, the arrangement may be more like Princeton Architecture as opposed to Harvard Architecture.

The first database 350 and the second database 355 are dynamically arranged, via a dynamic arrangement process (illustrated schematically as 370 in FIG. 3), into a modified database 372. In this example, the modified database 372 is an overall GATT database, expressing both the specification of the first service and the second service, and comprising both the first data and the second data. The first data in the overall GATT database is accessible to the first application 330 and the second data in the overall GATT database is accessible to the second application 335. The framework 300 is arranged so that the first application 330 and the second application 335 run in dependence on the overall GATT database.

The framework 300 further comprises a lightweight real-time operating system (RTOS) 380, a security API 382, a crypto-block 384, an embedded solution API 386, a memory management unit 388, an API and firmware OTAu module 390, a dynamic download, verification and instantiation module 392 and an application sandboxing/task switching module 394.

The framework is, in one example, a para-virtualisation framework. Such a framework allows a privileged component such as a software component to provide an abstraction of hardware resources. The para-virtualisation framework is based on the RTOS 380. The crypto-block 384 enables key sets to be registered, and can provide verification that applications presenting predefined key sets are allowed to operate in the framework an access predetermined resources. The security API 382 provides an interface by which the first application 330 and the second application 335 can interact with the crypto-block 384.

The API and firmware OTAu module 390, the dynamic download, verification and instantiation module 392 and the application sandboxing/task switching module 394 all, in one example, operate on the RTOS 380.

The first application 330 and the second application 335 can run on the RTOS 380.

In this example, the first application 330 can read and write data elements of the first data in the overall GATT database. Similarly, the second application 335 can read and write data elements of the second data in the overall GATT database. However, the first application 330 does not have access to the second data, and nor does the second application 335 have access to the first data. In other words, the first data can only be accessed by the first application 330 and the second data can only be accessed by the second application 335.

In this example, the first data and the second data are arranged independently, and in a segregated manner, in the overall GATT database. This facilitates the independent access to the first data by the first application 330 and to the second data by the second application 335.

Since the first data elements of the first data which are used in the operation of the first application 330 are distinct from the second data elements of the second data which are used in the operation of the second application 335, the operation of the applications is independent of one another. This means that the operation of one of the first application 330 and the second application 335 does not depend on the state of the other of the first application 330 and the second application 335, and nor does it depend on the state of the data elements of the other of the first application 330 and the second application 335.

The API and firmware OTAu module 390 facilitates the updating of the firmware and/or applications using OTAu (which may be wireless, such as by the BLE wireless protocol). This module enables interactions with systems off-chip so as, amongst other things, to facilitate querying of the framework as to the versions of firmware and/or applications (i.e. the first application 330 and the second application 335). In other words, the API and firmware OTAu module 390 is arranged to receive a request and to send a response. The request is, in one example, received from an update server located remotely from the framework on the chip, and is a request to identify the versions of at least one of the firmware currently employed in the framework 300, the first application 330 and the second application 335. The API and firmware OTAu module 390 is arranged, in response to the received request, to identify the requested versions and to send a message, for example back to the update server comprising information identifying the requested versions.

The API and firmware OTAu module 390 also, in one example, comprises a transceiver for transmitting and receiving data over a data link, for example to the update server. In one example, the transceiver is a wireless transceiver which operates using the BLE protocol. In other examples, the API and firmware OTAu module 390 may be arranged to access another transceiver located elsewhere on the chip. In this way, the API and firmware OTAu module 390 enables the receiving by the framework 300 of an update, such as to at least one of the first application 330 and the second application 335, using an OTAu mechanism.

The dynamic download, verification and instantiation module 392 is arranged, in one example, to periodically check with a remote update server to see whether any updates are available to at least one of the firmware currently employed in the framework 300, the first application 330 and the second application 335. An update may be determined to be available as a result of a check being made by the dynamic download, verification and instantiation module 392, by a request received from an update server, or otherwise. The dynamic download, verification and instantiation module 392 is arranged, once an update has been determined to be available, to dynamically download the update to the chip.

The download of the update is achieved, in one example, by downloading a single file or group of files in one go. In another example, the download of the update is achieved by downloading at least one data packet, the data packet forming a portion of the update, by storing the data packet, and by subsequently downloading at least one other data packet, which other data packet forms another portion of the update, and by combining the data packet and the other data packet so as to obtain the update. In this way, the update does not need to be downloaded all at once. This can be beneficial in devices in which access to a transceiver is required for the functionality of the device, leaving only periods in between this access during which updates can be downloaded. This ensures that the functionality of the device is not interrupted by the downloading of the update. The ability to download updates (which may be large relative to the amount of data typically transferred over the network) in a plurality of portions (which is not limited to two portions, but could be three or more portions) also enables the load on the network to be spread out. This can help ensure network stability, and/or that other network traffic is not disrupted by the transfer of the update over the network.

In one example, where the framework is on a device which forms part of a mesh network of devices, the data packet and the other data packet do not need to arrive at the framework by the same route. In other words, the data packet and the other data packet can arrive at the device on which the framework is provided by a direct or indirect route. The framework need not receive the data packet in advance of the other data packet. In other words, it does not matter in which order the packets arrive.

The dynamic download, verification and instantiation module 392 is, in one example, arranged, once the update has been downloaded (and combined if appropriate), to verify the update against one or more predetermined criteria. The criteria comprise, in one example, a requirement that a provided authorisation and/or authentication key matches a key held within the framework. The authorisation/authentication key may be provided together with and/or as part of the update, or separately. In one example, the key held within the framework is held at the crypto-block 384. In some examples, the criteria comprises an integrity check of the downloaded binary. Other verification steps could be taken instead of or as well as these steps.

The dynamic download, verification and instantiation module 392 is, in one example, arranged to instantiate at least one of the update, the first application 330 and the second application 335 (for example where the application is being freshly installed and/or updated by the update). In some examples, the update comprises a third application. In these examples, the dynamic download, verification and instantiation module 392 is arranged to instantiate this third application. In instantiating each respective application, the framework is arranged to dynamically arrange the modified GATT database to expose (allow access to) the application functionality.

The application sandboxing/task switching module 394 is arranged to enhance the security of the first application 330 and the second application 335 by enabling the two applications to be isolated from one another. The application sandboxing/task switching module 394 is, in one example, arranged to restrict the interactions between the first application 330 and the second application 335. The application sandboxing/task switching module 394 is arranged so that the first application 330 is allowed to access all the data and/or control structures it needs in order to run and so that the second application 335 is allowed to access all the data and/or control structures it needs in order run. In some examples, the application sandboxing/task switching module 394 is arranged to restrict access to at least one of the first application 330 and the second application 335 to data and/or control structures that each application does not need in order to run.

For example, the application sandboxing/task switching module 394 is arranged to allow the first application 330 to access a first portion of the overall GATT database in which is located the first data, but to restrict access to the first application 330 to a second portion of the overall GATT database in which is located the second data. Similarly, the application sandboxing/task switching module 394 is in one example arranged to allow the second application 335 to access the second portion of the overall GATT database in which is located the second data, but to restrict access to the second application 335 to the first portion of the overall GATT database in which is located the first data. Thus the application sandboxing/task switching module 394 can enable each application to run whilst at the same time ensuring that the running of one does not affect the other. The restriction of one application from access the data of the other application means that data cannot be accidentally shared between the applications, which enhances data security.

The vendor can provide a software development framework to develop applications that share the same resources by means of common APIs 320 (for example at least one of PIO, Model, BLE GAP/GATT and MESH) and define a number of independent, possibly segregated, GATT Services.

All the applications can be developed in a high level language like C and the tool-chain (a set of programming tools) makes sure that the compiled binary:
executes in non-privileged mode and all machine code instructions are restricted from switching operation mode from non-privileged to privileged;
interacts with the external world through the provided APIs only;
is mapped to adequate virtual memory addresses;
can be retargeted to severely constrained or legacy platforms where only monolithic deployment is achievable; and/or
is signed by the developer.

The vendor may provide a Cloud-based framework to at least one of deliver, sign, publish and maintain the applications 330 335. Encrypted and/or authenticated application modules may be stored in the Cloud and accessible by the framework of the chip to enable the framework of the chip to fetch and update applications running on the chip itself. This can lead to an increase in flexibility with which the functionality of the framework 300 may be accessed.
The vendor provides on chip a lightweight real-time operating system (RTOS)-based, para-virtualisation framework executing in unrestricted privileged mode so that:
upon each application instantiation, application-specific GATT databases are dynamically and securely arranged into a single GATT database (the modified database 372);
applications can register with the crypto-block 384 segregated, reserved encryption/signature application and application instance-specific keysets in order to guarantee each application's data integrity and confidentiality;
applications execute in restricted non-privileged mode and thus can neither access data and code of other applications or of the deployment framework, nor modify their GATT interface to the external world (no data leakage);
access to the GATT, GAP, CSRmesh, PIO and/or NVM APIs is allowed through trusted gateway functions (the arbitrator 365 in FIG. 3) that can:
   reserve or limit in time and scope sharing/ownership of a specific peripheral or functionality; and/or
   restrict a switch to privileged supervising mode to trusted gateway function code;
within the above limitations, resources are time-shared between applications and real-time constraints are matched by the RTOS 380.

In addition or alternatively to the above the vendor provides a dynamic deployment framework to:
download encrypted and signed applications (signed by the developer and/or within the distribution framework, and encrypted with the public key of the destination chip, or a symmetric key such as one obtained through a Diffie-Hellman key exchange);
decrypt and verify the application signatures;
instantiate the application and dynamically arrange the modified GATT database 372 to expose (allow access to) the application functionality; and/or
enable Over The Air updates (OTAu) of the framework 300 on the chip.

This technique allows, for example in the context of BLE device development, the definition of services in an independent manner, which are deployable as a co-existing group. This concept encompasses both execution and data, thus including segregation of data in the modified GATT database 372 in relation to the service accessed. Once this co-existence and segregation are possible, one can start considering finer grain OTAu operations such as allowing a per service (or per model) upgrade, addition or deletion.

The techniques described herein allow a third party to add a new service outside the initial development environment. In other words, where the first application (optionally also the second application) has been developed and deployed to a device, and is operating in the framework at that device, a third party may develop a third application without requiring knowledge of how the first (and possibly the second) application operates. The third application can be deployed to the framework, and the independent running of each application at the framework ensures that conflicts between applications are avoided and that each can operate effectively.

Note that whilst the techniques have been described herein with reference to first, second and third applications, it will be understood that these techniques can be extended to multiple applications, and are not limited to a particular number. The techniques can introduce the ability to swap functions or introduce new functions on old hardware.

The dynamic download and deployment of multi-vendor, securely segregated applications is advantageous for the re-use of large networks of low-cost devices without the need to install pleonastic, application-specific nodes and without needing to address the concern that data aggregated by the node for one application's walled garden is not leaked inside the device to another application, for example supporting data aggregation for another silo.

In one example, the manufacturer of the chip provides an application framework for the development, distribution and secure run-time deployment of applications, such as those of a customer or vendor. In addition to the description above, an entire eco-system may be defined which may cover lower aspects associated with the support of application-ware (service and model definitions), mechanisms for supporting OTAu, segregation of data at the GATT database layer as well as the requirement for OTAu as a service.

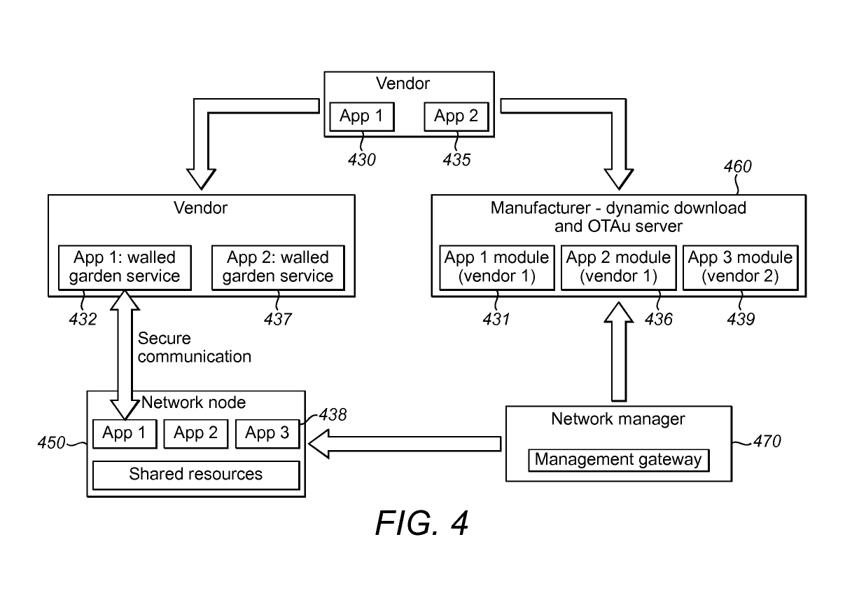

Examples of interactions of applications in a framework are shown schematically in FIG. 4. With reference to this figure, a vendor is able to develop one or more application: the first application App1 430 and the second application App2 435. The vendor can provide services for each application within ‘walled gardens’, so that each application runs in isolation from each other application. For example, the vendor can provide a walled garden service for the first application 432 and a walled garden service for the second application 437.

The applications themselves, i.e. one or more of the first application 430, the second application 435 and the third application 438 can run at a network node 450 and can access shared resources at that network node 450. The first application 430 running at the network node 450 can communicate securely with the walled garden service for the first application 432. In this way, data sent between the first application 430 and the walled garden service for the first application 432 is kept secure, and cannot be accessed the another application or walled garden.

The manufacturer of the chip on which the framework is provided can provide a dynamic download and OTAu server 460 for facilitating the update of applications already at the network node 450 and/or facilitating the download of new applications to the network node 450. At the dynamic download and OTAu server 460, a number of application-specific modules are provided. Each module can be provided by the relevant vendor. In other words, the vendor of each application can independently maintain the module relating to each respective application. Modules from different vendors can be hosted by the dynamic download and OTAu server 460. The applications deployed at the network node 450 are not limited to those developed by one vendor. The independent running of the applications means that applications from multiple vendors can be deployed and maintained at the same network node 450. For example, a first vendor can provide an App1 module 431 relating to the first application 430 and an App2 module 436 relating to the second application 435, and a second vendor can provide an App3 module 439 relating to the third application 438.

A network manager 470 provides a management gateway between the network node 450 and the dynamic download and OTAu server 460. This enables communications between the network node 450 and the dynamic download and OTAu server 460 which allows for the checking of the version of the application deployed at the network node 450 against the most recent version offered by the vendor, and allows for the update to the most recent version if appropriate. The network manager 470 and/or the management gateway of the network manager enables the provision of service-level (or model-level) management. In other words, a particular service can be updated, and this update pushed out to all relevant devices. In this system there is no need for management of the applications to be done at a device level. The network manager 470 is a convenient way of achieving such service-level management, but it could additionally or alternatively be achieved by, for example, the dynamic download and OTAu server 460 pushing out the update, or by allowing the network nodes to determine whether an update for a particular service is available, and possibly notifying other network nodes if a positive determination is made. Other ways of achieving this will be appreciated by a skilled person.

As has been briefly discussed above, the update of the application framework can occur in the context of a network of devices, such as a mesh network of BLE-enabled devices. These devices may automatically join a mesh network when they are in range of other such devices. This is of particular interest in the field of low powered devices. Protocols such as BLE mean that devices capable of wireless communication can be powered for a number of years from a simple battery without the need for recharging. The low cost of these devices, together with the prospect of them having at least as long a lifetime as some common consumer goods, opens up the possibility that the devices could be implanted in a wide range of articles that might be found in a domestic or industrial setting, or that might be carried by a person. Examples include mobile phones, light bulbs, wallets, desks, shopping bags, articles of clothing and door keys. Some of these items may be expected to be static. Others will be moved around. It can be imagined that whatever low power devices happen to be together in one place could adventitiously cooperate to form a mesh transport network. That transport network could relay communications between devices that cannot communicate directly, without someone having to specifically provide underlying infrastructure for the network.

Thus at least one of the checks for new application versions, the request for application versions and response, and the update may be relayed over the network. This enables the provision of devices which can each receive updates, but where, for example, only one node in a network need by connectable to an external resource such as the update server.

In one example, the processor comprises a microprocessor and a non-volatile memory. The non-volatile memory stores in non-transitory form computer executable instructions that are executable by the processor, for example by the microprocessor, to cause the processor to implement at least one of the systems and methods described herein. In one example, the processor and the memory are provided separately. The memory may be provided additionally to or in place of the non-volatile memory. The memory may also be non-volatile.

In one example the processor of the integrated circuit chip is arranged to process computer executable instructions (for example program code) configured to control the operation of the integrated circuit chip in order to perform at least one of the systems and methods described herein.

The computer executable instructions could be stored in non-transitory form at a machine readable medium such as a memory (RAM, cache, hard disk etc.), optical or magnetic storage. A machine readable medium might comprise several memories, such as on-chip memories, computer working memories, and non-volatile storage devices.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An integrated circuit chip comprising a processor, memory for storing program instructions for execution on the processor and a database for reference by the processor during execution of the program instructions, the chip further comprising an application framework configured to:
support a first application and a second application, the first application being associated with a first database and the second application being associated with a second database, the first database comprising first data associated with the first application and the second database comprising second data associated with the second application;
dynamically arrange a modified database in dependence on the first database and the second database, the modified database comprising the first data and the second data such that the first data and the second data are independent in the modified database.

2. The integrated circuit chip according to claim 1, in which the application framework is arranged so that the first application only has access to a first portion of the modified database where the first data is stored, and so that the second application only has access to a second portion of the modified database where the second data is stored.

3. The integrated circuit chip according to claim 1, in which the first application and the second application define independent services.

4. The integrated circuit chip according to claim 1, in which the application framework is configured to instantiate the first application and the second application.

5. The integrated circuit chip according to claim 1, in which the application framework is configured to dynamically create the modified database in dependence on the first database and the second database.

6. The integrated circuit chip according to claim 1, the integrated circuit chip comprising the modified database.

7. The integrated circuit chip according to claim 1, in which the framework is configured to, in dynamically arranging the modified database in dependence on the first database and the second database, combine the first database and the second database so as to arrange the modified database.

8. The integrated circuit chip according to claim 1, in which the framework is configured to dynamically arrange the modified database at run-time.

9. The integrated circuit chip according to claim 1, in which at least one of the first database and the second database is a GATT database.

10. The integrated circuit chip according to claim 1, in which at least one of the first database and the second database is application-specific.

11. The integrated circuit chip according to claim 1, the chip comprising a crypto-block, and the framework being configured to enable at least one of the first application and the second application to register at least one key set with the crypto-block.

12. The integrated circuit chip according to claim 1, in which the framework is configured to cause at least one of the first application and the second application to execute in restricted non-privileged mode.

13. The integrated circuit chip according to claim 1, in which the framework is configured to enable the first application and the second application to share resources through one or more common application programming interfaces (APIs).

14. The integrated circuit chip according to claim 13, in which the framework is configured to enable access to the one or more common APIs through at least one trusted gateway function.

15. The integrated circuit chip according to claim 14, in which the framework is configured so that said at least one trusted gateway function at least one of reserves and limits at least one of the sharing and ownership of designated functionality.

16. The integrated circuit chip according to claim 14, in which the framework is configured so that said at least one trusted gateway function restricts a switch to privileged non-restricted supervising mode to trusted gateway function code.

17. The integrated circuit chip according to claim 1, the chip comprising a real-time operating system arranged to facilitate the operation of the framework in unrestricted privileged mode.

18. The integrated circuit chip according to claim 1, in which the framework is configured to enable at least one of the first application and the second application to be at least one of defined, developed, signed, deployed and updated in isolation of one another.

19. The integrated circuit chip according to claim 1, in which the framework is configured to enable at least one of deployment, maintenance and update of at least one of the first application and the second application by a wireless protocol.

20. The integrated circuit chip according to claim 1, in which the framework is a para-virtualisation framework.
